(19) United States
(12) Patent Application Publication
(10) Pub. No.: US 2026/0368666 A1
(43) Pub. Date: Nov. 19, 2026

(54) SYSTEM AND PROCESS FOR MINING OPERATIONS EXECUTION

(71) Applicant: CSHIFTS INC., Sudbury (CA)

(72) Inventor: Aubrey SARGEANT, Sudbury (CA)

(21) Appl. No.: 19/677,450

(22) Filed: May 14, 2026

Related U.S. Application Data
(60) Provisional application No. 63/805,684, filed on May 14, 2025.

(51) Int. Cl. G06Q 10/0631; G06F 16/242; G06F 40/205; G06F 40/284; G06F 40/30; G06Q 50/02

(52) U.S. Cl. CPC G06Q 10/06316; G06F 16/2428; G06F 40/205; G06F 40/284; G06F 40/30; G06Q 50/02

(57) ABSTRACT

There is provided a computer-implemented method and a system for mining operations execution. The method comprises obtaining, at a processing device, transmittal data describing one or more work activities to be performed in a mining environment, applying, by a data parsing engine operatively coupled to the processing device, mining-specific rule-based semantic parsing to the transmittal data to extract therefrom a plurality of work package tasks, each work package task having at least one of a deadline, a task description, at least one required worker qualification, a resource requirement, and a cost estimate associated therewith, assigning, by a planning engine operatively coupled to the data parsing engine and to the processing device, each work package task to designated personnel, and outputting, by the processing device and via a graphical user interface, the plurality of work package tasks as assigned.

### CROSS-REFERENCE TO RELATED APPLICATIONS

This patent application claims priority of U.S. application No. 63/805,684 filed May 14, 2025, the entire contents of which are incorporated herein by reference.

### TECHNICAL FIELD

The improvements generally relate to the field of mining operations, and more particularly to the execution of work activities related to mining operations.

### BACKGROUND

A large amount of operational data is generated daily and, on a shift-by-shift basis, in underground mining operations. This data, ranging from production metrics and equipment statuses to safety incidents and design updates, is critical to planning, coordination, and reporting at the start and end of each shift. During the shift change routine, this data must be reviewed, interpreted, documented, and communicated to ensure safe and continuous mining operations.

In current practice, mining supervisors and engineers often rely on informal and disjointed methods to collect and compile this operational data. For instance, workers may request a list of transmittals (such as which documents arrived, who reviewed them, and their status) from colleagues to brief underground crews during the morning lineup. However, the process is fraught with inefficiencies: files may be scattered across shared drives, buried in inconsistently named folders, or spread across spreadsheets, emails, and unsaved Word documents. As a result, by the time information is manually pieced together, underground teams may already be deployed, increasing the risk of miscommunication and design errors.

Several enterprise-level mining software platforms have emerged to improve data collection and operational decision-making. Solutions such as Deswik Ops™ (Deswik™) and Work Manager™ (MineRP™) offer real-time shift scheduling, task tracking, and monitoring capabilities. However, these platforms often require significant capital investment, advanced infrastructure (e.g., Long Term Evolution (LTE) cables, sensors, centralized control rooms), and dedicated technical personnel to implement and operate. This makes them inaccessible for many junior and mid-tier mining companies that lack the resources for such systems.

Moreover, existing systems either lack a mining-specific context or are overly complex for adoption at the shift supervisor level. Generic platforms do not integrate seamlessly with local file workflows, Structured Query Language (SQL)-based reporting systems, or the operational routines of underground crews. Additionally, mainstream software packages often omit the Responsible, Accountable, Consulted, and Informed (RACI) framework, making it difficult to establish clear accountability in distributed teams without significant customization.

Therefore, there is a need for improvement.

### SUMMARY

Accordingly, there exists a need for an affordable, mining-specific solution that bridges the gap between structured engineering workflows and practical shift-level execution without requiring complex infrastructure or specialized training.

The instant disclosure addresses this gap by providing a lightweight yet powerful software tool specifically designed for mining operations. The system enables SQL-integrated document control, folder-based transmittal mapping, real-time status filtering, and RACI-aligned task assignments. The system described herein supports rapid shift planning, facilitates review logging, and improves communication between design teams and field crews. Designed with underground realities in mind, the system empowers users to manage tasks, documents, and responsibilities from a single interface optimized for efficiency, traceability, and operational continuity. Its use for the generation of workplans for underground mining operations can eliminate ambiguity and accountability from shift start to sign-off.

In some embodiments, the system dynamically determines execution readiness for work package tasks based on governance indicators, equipment state, workforce availability, document approval status, and operational constraints. Tasks may remain scheduled while simultaneously being classified as not execution-ready, thereby enabling mining operations personnel to distinguish planned work from executable work.

The system further enables continuous synchronization between field execution state and governance state such that operational observations, equipment updates, and execution outcomes dynamically influence governance indicators and execution prioritization.

In accordance with one aspect, there is provided a computer-implemented method for mining operations execution. The method comprises obtaining, at a processing device, transmittal data describing one or more work activities to be performed in a mining environment, applying, by a data parsing engine operatively coupled to the processing device, mining-specific rule-based semantic parsing to the transmittal data to extract therefrom a plurality of work package tasks, each work package task having at least one of a deadline, a task description, at least one required worker qualification, a resource requirement, and a cost estimate associated therewith, assigning, by a planning engine operatively coupled to the data parsing engine and to the processing device, each work package task to designated personnel, and outputting, by the processing device and via a graphical user interface, the plurality of work package tasks as assigned.

In accordance with another aspect, there is provided a computer-implemented system for mining operations execution. The system comprises a processing unit having a data parsing engine and a planning engine operatively coupled thereto and a non-transitory computer-readable medium having stored thereon program instructions executable by the processing unit for obtaining transmittal data describing one or more work activities to be performed in a mining environment, applying, at the data parsing engine, mining-specific rule-based semantic parsing to the transmittal data to extract therefrom a plurality of work package tasks, each work package task having at least one of a deadline, a task description, at least one required worker qualification, a resource requirement, and a cost estimate associated therewith, assigning, at the planning engine, each work package task to designated personnel, and outputting, via a graphical user interface, the plurality of work package tasks as assigned.

Many further features and combinations thereof concerning embodiments described herein will appear to those skilled in the art following a reading of the instant disclosure.

### BRIEF DESCRIPTION OF THE DRAWINGS

In the appended drawings:

FIG. 1 is a block diagram of a system for mining operations execution, in accordance with one embodiment;

FIG. 2A is a screenshot showing Shift Line-Up Software Interface, in accordance with one embodiment;

FIG. 2B is a screenshot showing Shift Reporting Software Interface, in accordance with one embodiment;

FIG. 2C is a screenshot showing Operations Crew Availability Interface, in accordance with one embodiment;

FIG. 2D is a screenshot showing Crews Assigned to Supervisors Interface, in accordance with one embodiment;

FIG. 2E is a screenshot showing Ground Support Shift Reporting Interface, in accordance with one embodiment;

FIG. 3A is a screenshot showing a user interface for building a RACI chart design flow, in accordance with one embodiment;

FIG. 3B is a screenshot showing a user interface for filtering tasks by project, in accordance with one embodiment;

FIG. 3C is a screenshot showing a user interface for creating and filtering tasks, in accordance with one embodiment;

FIG. 3D is a screenshot showing a user interface for creating, filing and filtering a transmittal, in accordance with one embodiment;

FIG. 3E is a screenshot showing a user interface for moving transmittals between bins and file directories, in accordance with one embodiment;

FIG. 3F is a screenshot showing a user interface for assigning transmittals, review documents and trace progress, in accordance with one embodiment;

FIG. 3G is a screenshot showing a user interface for showing a reviewed file being uploaded to a server, in accordance with one embodiment;

FIG. 3H is a screenshot showing a user interface for integrating transmittal management and execution of the work from shift to shift, in accordance with one embodiment;

FIG. 3I is a screenshot showing a shift-based execution interface, in accordance with one embodiment;

FIG. 3J is a screenshot showing a user interface for providing governance context and managing of activities within execution, in accordance with one embodiment;

FIG. 3K is a screenshot showing a user interface for execution to governance navigation, in accordance with one embodiment;

FIG. 3L is a screenshot showing a user interface showing RACI assignment with execution context, in accordance with one embodiment;

FIG. 4A is a flowchart of a method for mining operations execution, in accordance with one embodiment;

FIG. 4B is a flowchart of a method for mining operations execution, in accordance with another embodiment;

FIG. 5 is a schematic diagram of an example computing device, in accordance with one embodiment;

It will be noted that, throughout the appended drawings, like features are identified by like reference numerals.

### DETAILED DESCRIPTION

It is to be understood that the instant disclosure is not limited to the particular embodiments described below, as variations of these embodiments may be made and still fall within the scope of the appended claims. It is also to be understood that the terminology employed herein is for the purpose of describing particular embodiments and is not intended to be limiting. Instead, the scope of the instant disclosure will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “shift” refers to a defined work period in mining operations – either underground or open-pit – during which operational activities, inspections, and tasks are executed. The term “shifters” encompasses supervisors, engineers, and coordinators who organize and execute these tasks by shifts. Shifters and shift handovers rely on accurate data exchange, contextual documentation and clear accountability.

As used herein, the term “notebook” refers to comprehensive note-taking and synchronization of shift activities. The term suggests seamless coordination across people (RACI roles, project members), tasks (work packages, assignments), documents (transmittals, reviews), and time (across shift changes or daily schedules). Together, the solution described herein implies a real-time, collaborative system where operations are kept in sync. No gaps, no lost context, and no repeated errors are found between teams or shifts.

As used herein, the term “transmittal” refers to a formally logged exchange of one or more engineering or operational documents, optionally accompanied by comments, status updates, or shift-specific notes. Each transmittal describes one or more work activities to be performed (e.g., in a mining environment) and includes metadata such as discipline, branch, revision, and timestamp information.

As used herein, the term “value proposition” or “value delivered to the user” refers to a modern mining-specific coordination platform for aligning shift-based operations, ensuring tasks, responsibilities, and documents stay in sync across mining teams and timelines. The value proposition is designed to eliminate ambiguity and improve accountability from shift start to sign-off.

As used herein, the term “reviewed file” refers to a version of a document that has been marked up or finalized by a reviewer and saved to a designated /Reviews/ folder (e.g., as an audit trail record logged in a relational database). These files may be traceable by reviewer name, review date, or revision status.

As used herein, the term “SQL” refers to a programming language used for managing and querying data in relational database systems such as Microsoft SQL Server.

As used herein, the term “execution” refers to the actual delivery of tasks and activities. In the context of mining operations (e.g., underground or surface), execution relates to the actual carrying out of mining activities to extract and process resources according to plan. Examples of mining activities which are executed (also referred to herein as “execution activities”) include, but are not limited to, production activities (e.g., drilling, blasting, crushing, etc.), mine planning implementation, equipment operation and maintenance (e.g., managing fleets), workforce coordination (e.g., shift management and crew dispatch), health and safety practices (e.g., applying safety procedures on the ground), and environmental controls (e.g., waste management).

As used herein, the term “governance” refers to the framework, rules, and oversight mechanisms guiding and controlling execution. In the context of mining operations, governance relates to ensuring that mining operations are safe, compliant, and economically sound. Example of governance components include, but are not limited to, regulator compliance (e.g., adhering to mining laws, environmental regulations, etc.), Health, Safety & Environment (HSE) oversight (e.g., policies, audits), strategic decision-making (e.g., to meet production targets), risk management (e.g., identifying operational, geological, and environmental risks), financial oversight (e.g., budget approval and cost control frameworks), and accountability and reporting.

As used herein, the term “execution readiness” refers to a dynamically determined operational state indicating whether a work package task is capable of safe and effective execution based on one or more operational, governance, equipment, workforce, environmental, document-control, or dependency-related conditions.

As used herein, the term “governance context” refers to governance-related operational information (e.g., governance indicators) associated with a work package task, including risks, decisions, operational readiness indicators, compliance requirements, acknowledgements, blockers, approvals, and scheduling constraints.

As used herein, the term “execution state” refers to the current operational condition of a work package task including planned state, active state, blocked state, delayed state, completed state, suspended state, or readiness status.

As used herein, the term “execution context” refers to execution-related operational information associated with a work package task, including discipline, branch, work package type, crew association, project context, execution readiness state, governance conditions, shift assignment, personnel availability, operational escalation conditions, and/or historical assignment patterns.

Described herein are systems and methods for managing the execution of shift-based mining operations (also referred to herein as a “Shifter’s NoteBook”). More specifically, the instant disclosure is centered around role-aware tasks and documents assignment using the RACI matrix model, automated transmittal generation, and document organization, integrated review logging with version control and audit trails, SQL Server Reporting Services (SSRS)-powered report access from within an application and file system synchronization across staging, review, and final distribution folders.

In some embodiments, the system comprises means that allow for the identification and work schedule for each shift.

In some embodiments, the system comprises means that allow for the preparation of personalized shift cards for each worker on shift.

In some embodiments, the system comprises means that facilitate access to shift change data, processing, and decision making.

In some embodiments, the system comprises means that allow for start and end of shift reporting.

In some embodiments, the system comprises means that allow for the share of information between shift coordinators at the end of each shift.

Compared to existing systems, the system described herein is easy to install and use and does not require extensive upfront capital, including extensive operator training.

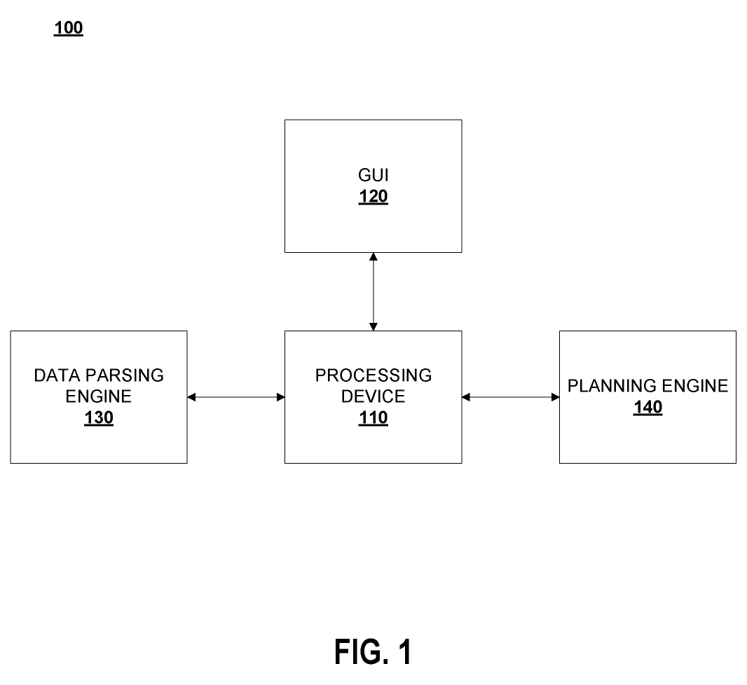

Referring to FIG. 1, the systems and methods described herein enable users to instantly retrieve a live, filtered list of incoming transmittals, associated drawings, assigned reviewers, and review statuses. In one embodiment, this information is pulled directly from a structured database and cross-verified with file system paths. The system 100 of FIG. 1 automatically organizes documents into discipline-based folder structures, logs review actions in real time, and prevents conflicting feedback by locking files during review. As a result, what was once a manual and error-prone process is now implemented using a streamlined briefing tool tailored to the speed and complexity of underground and surface mining operations.

As further contextualized by the architecture shown in FIG. 1, platforms such as Aconex™ and Bluebeam™ lack the integration and mining specificity required for real-time, role-aware shift execution. Aconex™ often relies on manual folder setup and lacks visibility into shift-based workflows. Bluebeam™, while effective for markup, does not support end-to-end file lifecycle tracking across shifts. In contrast, the present system synchronizes engineering data, planning assignments, and operational feedback in real time (via integrated components such as a Graphical User Interface (GUI) 120, structured data parser (also referred to herein as a Natural Language Processing, NLP, engine) 130, and planning engine 140) ensuring continuous task execution regardless of user location or connectivity.

In operation, and as shown in FIG. 1, a processing device 110 tracks shift-based tasks organized by discipline, branch, and shift. The structured data parsing engine (NLP engine) 130 automatically extracts data (i.e. work package tasks) from each transmittal, including task descriptions, required worker qualifications, resource needs, deadlines, and cost estimates. In one embodiment, the data parsing engine 130 uses rule-based semantic parsing tailored to mining operations. Instead of generalized natural language techniques, the data parsing engine 130 uses mining-specific keywords, document naming conventions, and pattern-matching logic to identify and extract structured data from filenames, portable document format (PDF) files, and tabular transmittal inputs. This enables accurate metadata extraction even in semi-structured or inconsistently formatted transmittals, without requiring extensive machine learning training.

In one embodiment, the rule-based semantic parsing performed by data parsing engine 130 comprises applying a tokenizer to segment the transmittal data into discrete lexical units, matching the discrete lexical units against a stored dictionary of mining-specific keywords (comprising, for instance, discipline classification tokens or entries, branch identifier tokens, and revision designator tokens), and, upon detecting a match, extracting the work package tasks by extracting and storing the matched token(s) as structured metadata field(s) in the relational (e.g., SQL) database, optionally with associated timestamp values. The data parsing engine 130 may be configured to operate as a deterministic finite-state parser that traverses character sequences from the input transmittal data against a predefined set of expression patterns encoding mining document naming conventions. In some embodiments, no gradient-based parameter optimization or statistical model inference is performed during extraction, such that identical inputs produce identical extraction outputs without depending on machine learning training data (i.e. without invoking a trained machine learning model or neural network).

The parsed data is formatted and returned by the data parsing engine 130 to the processing device 110, which provides operational, logistical, governance-related, and technical information associated with the work package tasks to the planning engine 140. The planning engine 140 uses this information to determine execution sequencing, execution readiness state, task prioritization, and shift-based work coordination for the work package tasks. In some embodiments, the planning engine 140 applies optimization heuristics, rule-based operational logic, constraint-satisfaction processing, and/or machine learning techniques to evaluate the work package tasks against operational constraints associated with mining activities.

In one embodiment, the planning engine 140 applies mining-specific execution logic including safety-based task sequencing, equipment operational readiness conditions, workforce availability conditions, governance indicators, document approval states, environmental constraints, dependency conditions, and/or shift-alignment requirements. Tasks may comprise resource extraction activities, equipment maintenance activities, inspections, development activities, ground support activities, haulage activities, or other underground or surface mining operations.

In one embodiment, the planning engine 140 is configured to execute a constraint-satisfaction algorithm that evaluates the work package tasks against a multi-dimensional constraint set stored in a relational database. The constraint set may comprise safety-based task sequencing constraints derived from geotechnical hazard data, equipment operational readiness conditions indicating whether prerequisite equipment is in a serviceable state, governance-related execution constraints, workforce qualification requirements, predecessor task completion dependencies, and/or temporal shift-boundary alignment constraints associated with remaining shift duration.

The planning engine 140 may dynamically determine an execution readiness state for each work package task based on evaluation of the constraint set. Work package tasks determined to be not execution-ready may remain visible within a schedule while being restricted from execution assignment, flagged for escalation, dynamically reprioritized, or associated with governance review actions.

The planning engine 140 may iteratively reorder, suppress, reprioritize, or reschedule work package tasks until the evaluated operational constraints are satisfied or a conflict condition is identified for manual review.

In one embodiment, RACI integration is achieved by associating each work package task record with a role matrix (also referred to herein as a “responsibility assignment matrix” or a “role assignment table”) comprising a plurality of responsibility assignment records defining a plurality of user roles including Responsible, Accountable, Consulted, and Informed roles. When work package tasks are created, imported, modified, or reassigned via transmittals or execution updates, the planning engine 140 automatically evaluates role assignments using a pre-configured RACI table stored in the relational database.

The planning engine 140 may assign users to one or more responsibility roles based on execution context including discipline, branch, work package type, crew association, project context, execution readiness state, governance conditions, shift assignment, personnel availability, operational escalation conditions, and/or historical assignment patterns. In one embodiment, the planning engine 140 executes one or more parameterized database queries against an indexed role-assignment table using one or more execution-context parameters associated with the work package task.

In one embodiment, responsibility assignments are supported at both a work package level and a task level, such that task-level responsibility assignments may inherit one or more responsibility attributes from work package-level assignments while selectively overriding one or more inherited responsibility attributes based on execution context, operational state, governance state, or shift-specific conditions.

The role-based associations may control operational visibility, execution permissions, governance interaction privileges, acknowledgment requirements, escalation routing, notification delivery, and/or execution coordination behavior. Responsible users may be granted execution-update permissions and operational alerts, Accountable users may be granted supervisory override privileges and escalation authority. Consulted users may be granted governance-review or approval authority, and Informed users may be granted restricted visibility into execution summaries, governance summaries, or operational status information.

In some embodiments, the planning engine 140 dynamically modifies responsibility assignments in response to execution-state changes, governance-indicator changes, personnel availability changes, shift-transition events, or operational escalation conditions. The planning engine 140 and/or the processing device 110 may further preserve (e.g., store in memory) responsibility continuity information and execution context information associated with the work package tasks across shift transitions such that operational context associated with incomplete, delayed, blocked or reassigned work package tasks remains associated with designated personnel between shifts.

The planning engine 140 and/or the processing device 110 may log the responsibility assignments as records in the relational database, each record comprising a task identifier, a designated personnel identifier, an associated role designation, one or more execution-state indicators, governance-related metadata, and/or target execution deadlines associated with the work package task. Administrators may review, override, approve, or audit the responsibility assignments via the GUI 120. All assignment modifications, overrides, acknowledgements, and execution-state changes may be recorded by the processing device 110 to maintain an auditable operational history associated with the work package tasks.

Once finalized, the resulting workplans are sent by the planning engine 140 back to the processing device 110, which provides them to the GUI 120 for visualization and user interaction.

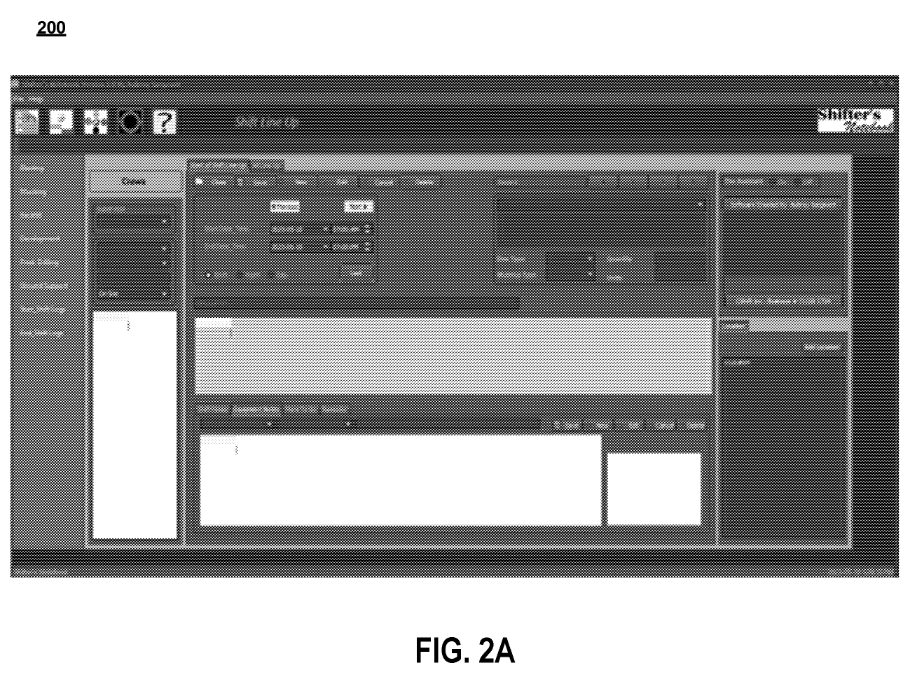

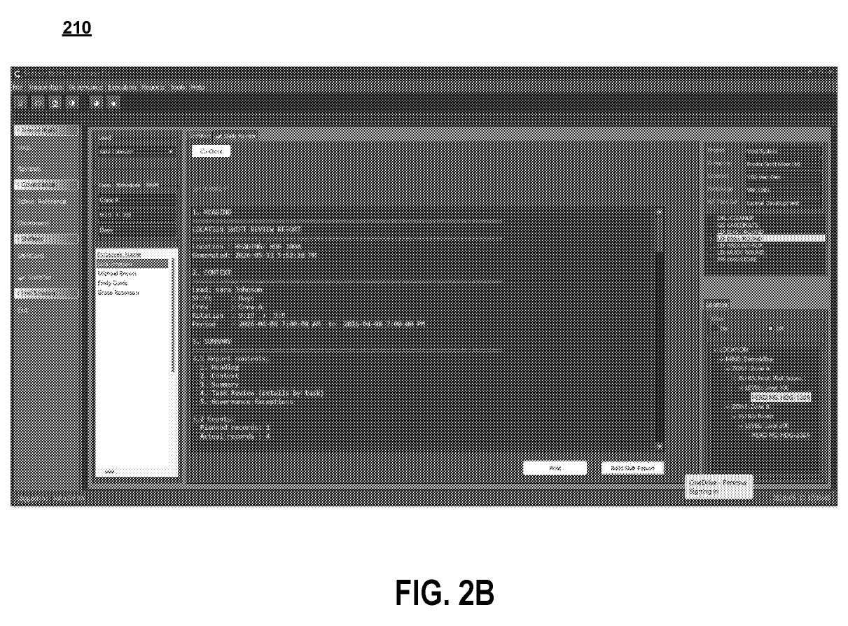

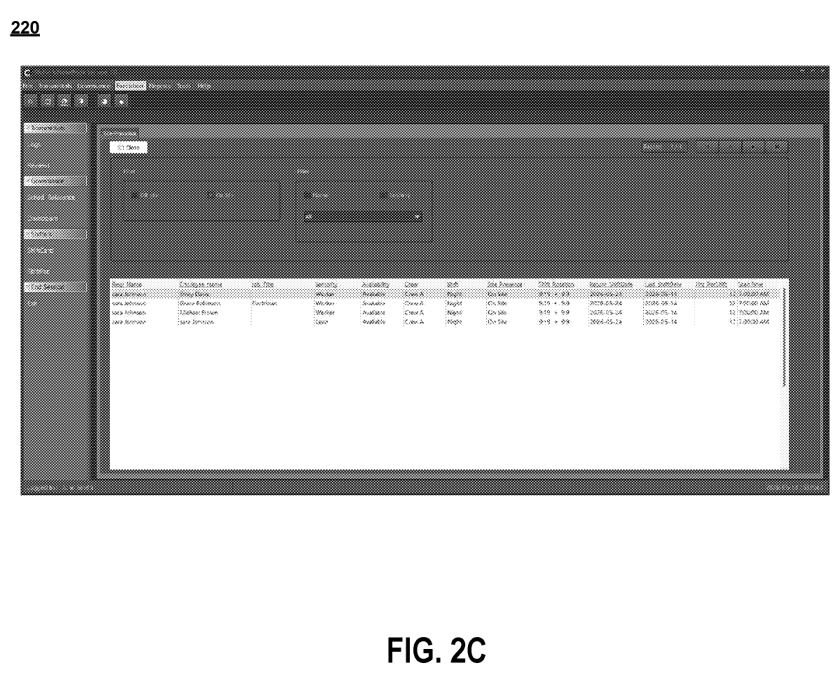

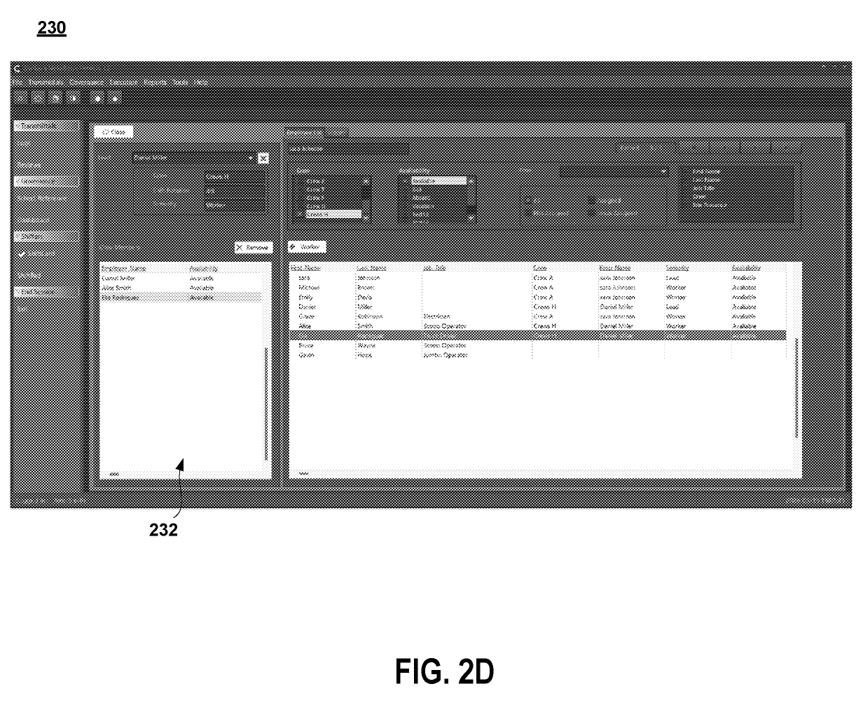

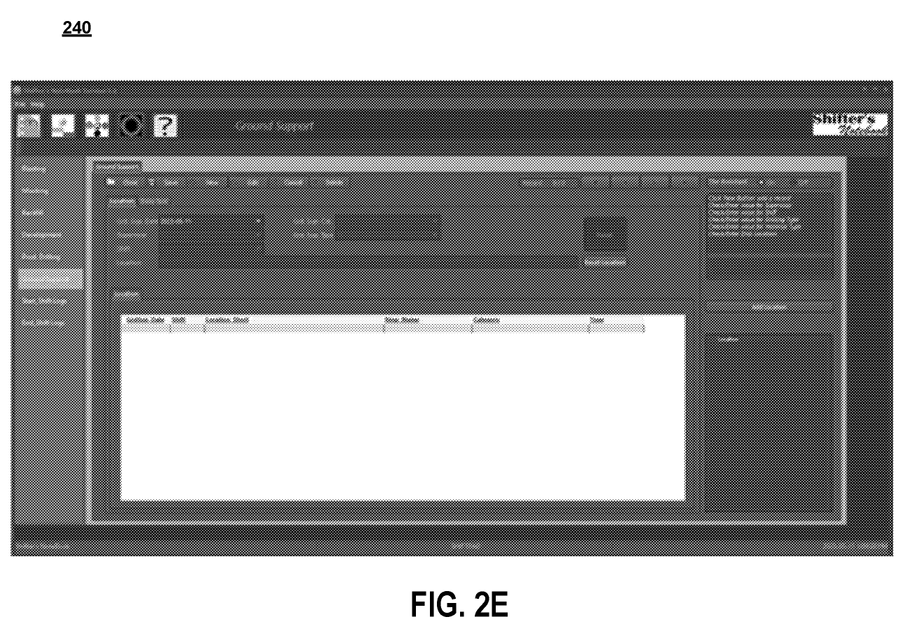

Referring to FIGS. 2A-2E, screenshots are presented showing various embodiments of the instant disclosure. FIG. 2A presents a screenshot 200 showing an aspect of the Shift Line-Up Software Interface. Accordingly, the systems and methods described herein provide means for managing shift line-up. FIG. 2B presents a screenshot 210 showing an aspect of the Shift Reporting Software Interface. Accordingly, the systems and methods described herein provide for means for managing shift reporting. FIG. 2C presents a screenshot 220 showing an aspect of the Operations Crew Availability Interface. Accordingly, the systems and methods described herein provide for means for managing crew availability operations. FIG. 2D presents a screenshot 230 showing an aspect of the Crews Assigned to Supervisors Interface. Accordingly, the systems and methods described herein provide for means for managing assignment of crews to supervisors. FIG. 2E presents a screenshot 240 showing an aspect of the Ground Support Shift Reporting Interface. Accordingly, the systems and methods described herein provide for means for managing ground support shift reporting.

FIG. 2D shows the shift assignment interface where crew supervisors (shifters) can select the shifter responsible for the crew and with a click button routine add members to their team based on availability, seniority and crew type. In the embodiment of FIG. 2D, worker “Daniel Miller” is selected as responsible for “Crew H” and new members (listed on the side panel 232 presented by the GUI 120) are added to the team by interacting with the GUI 120.

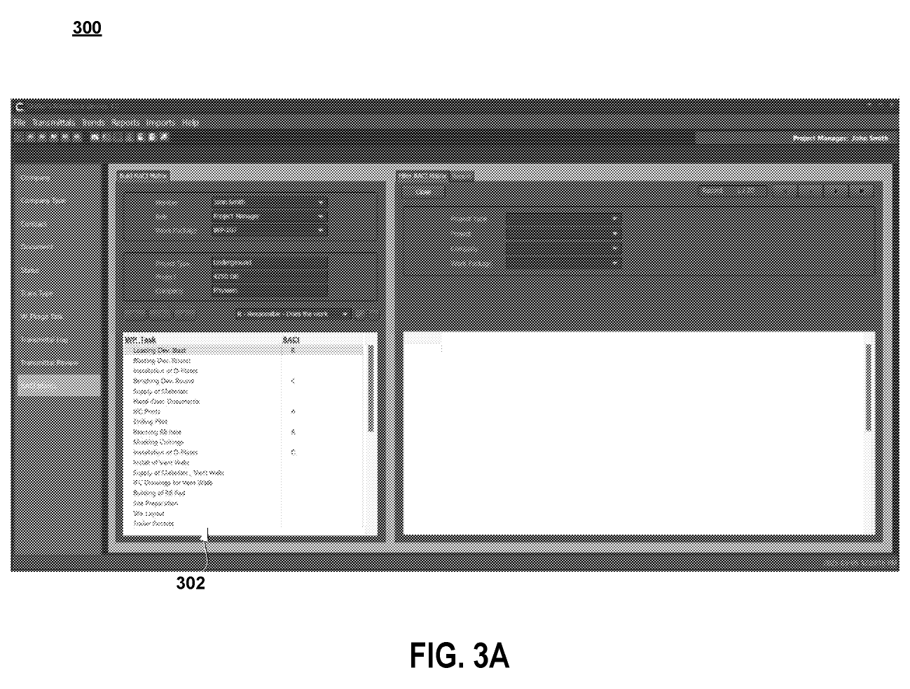

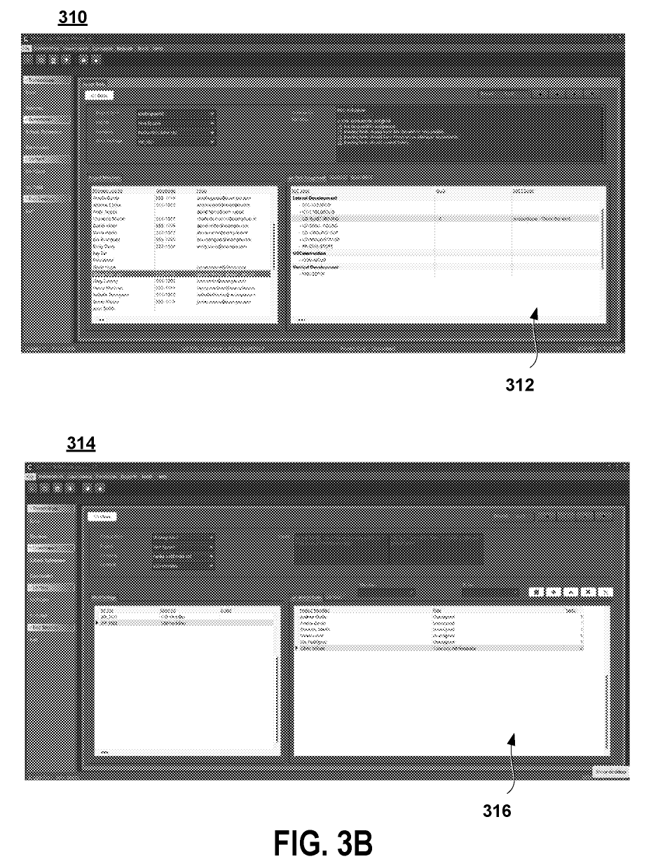

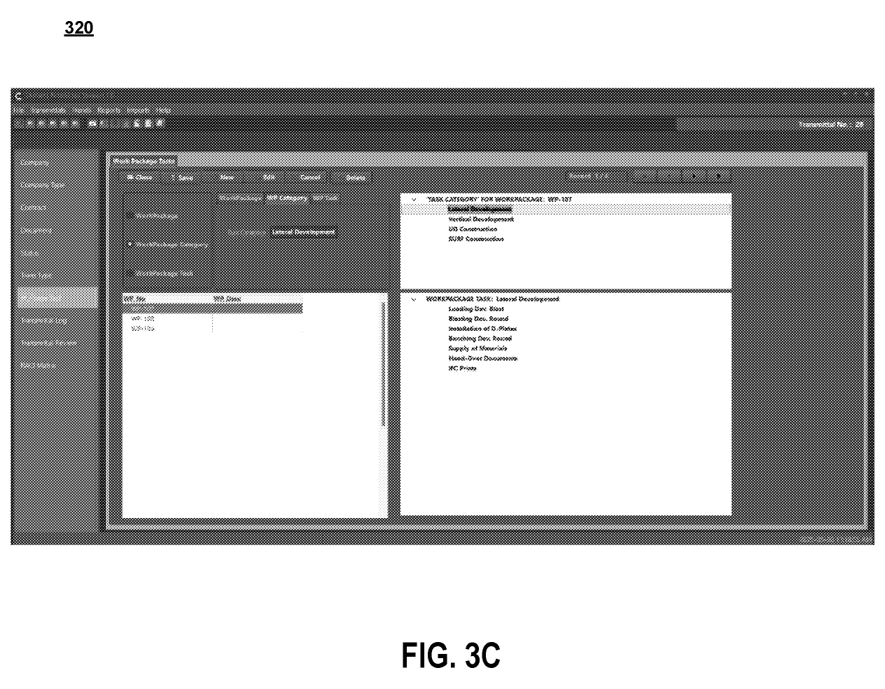

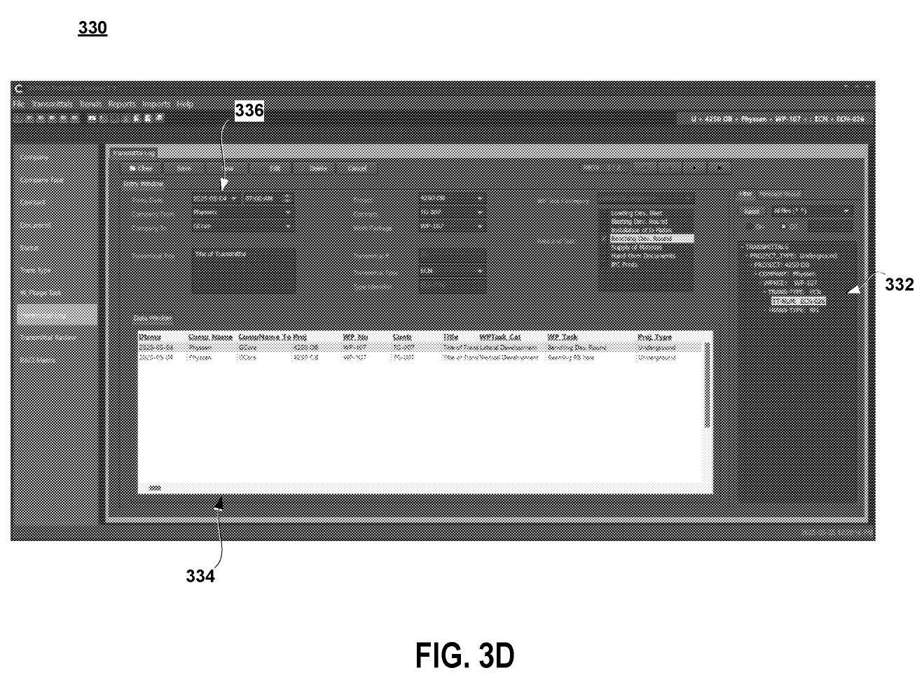

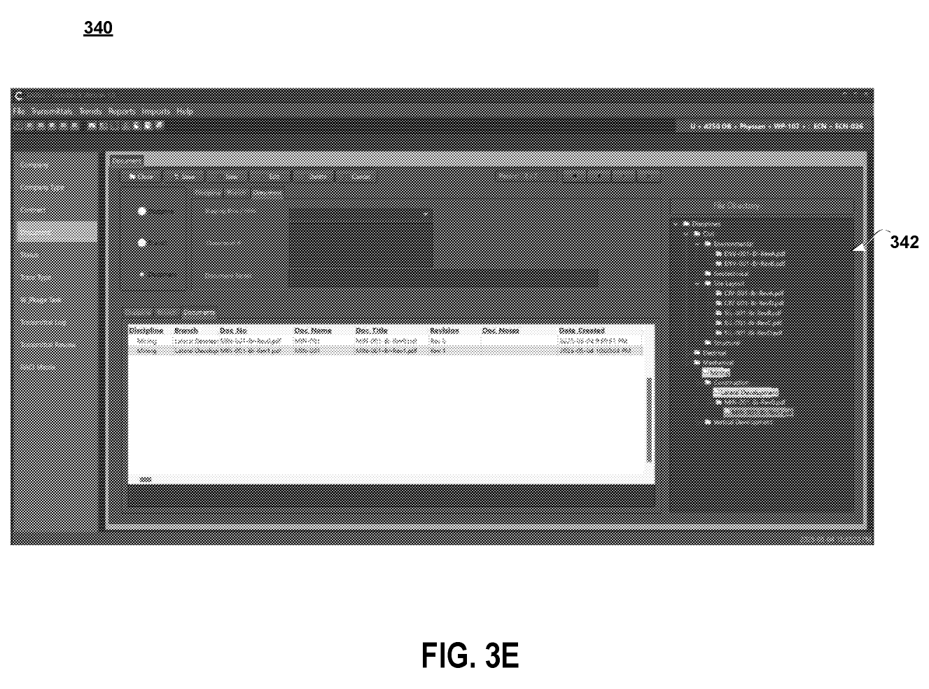

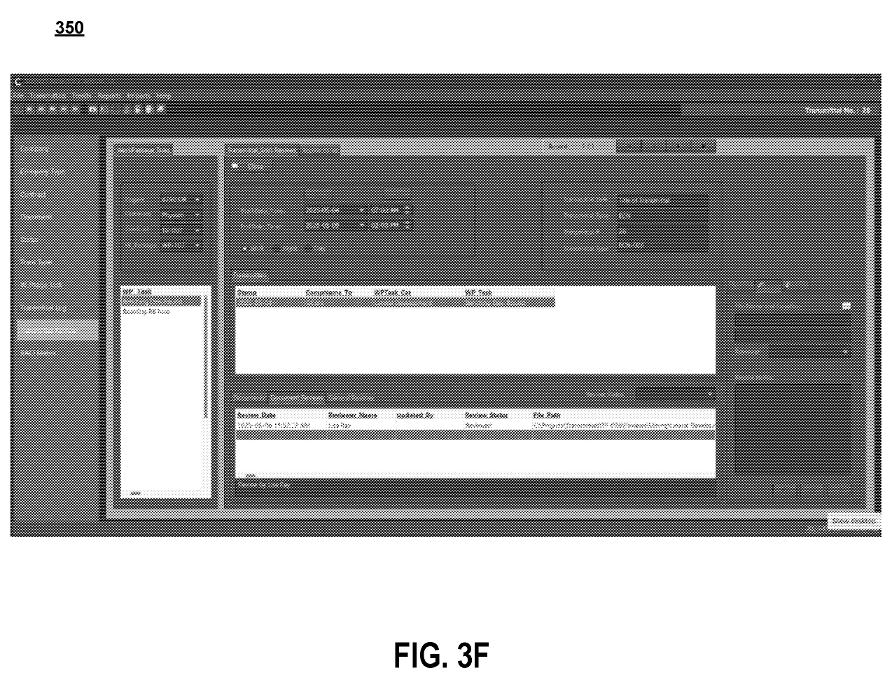

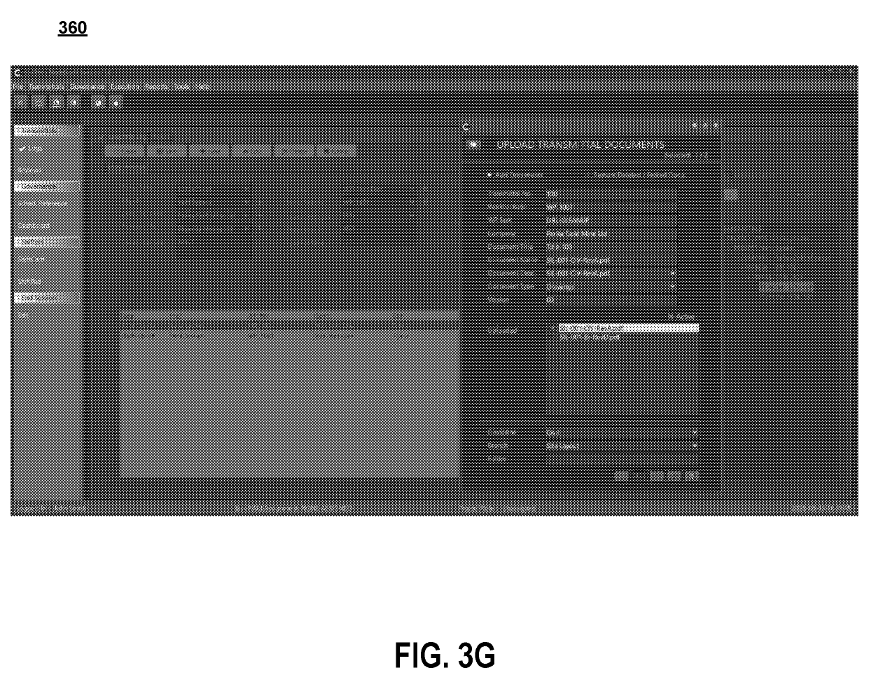

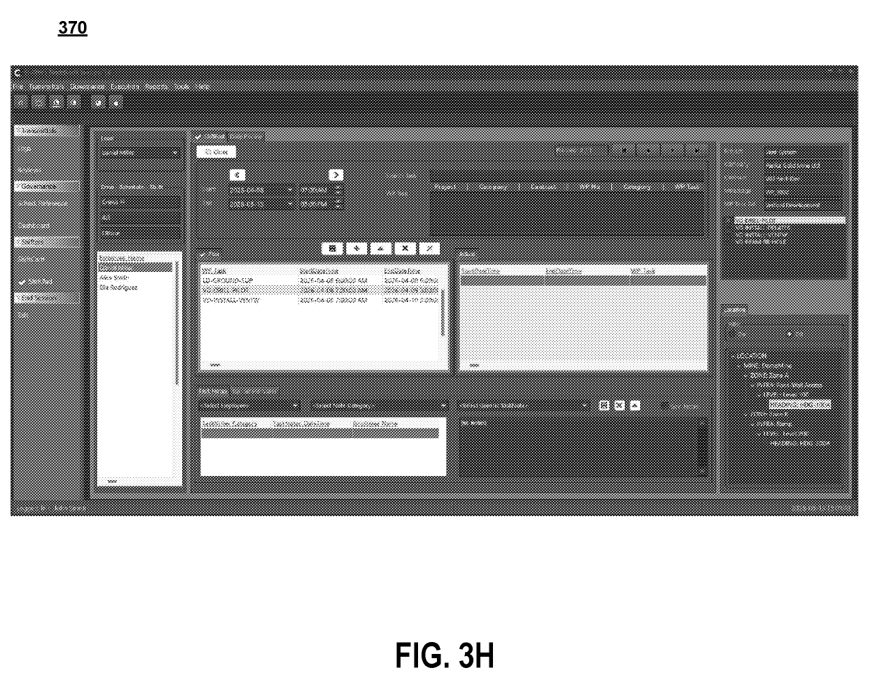

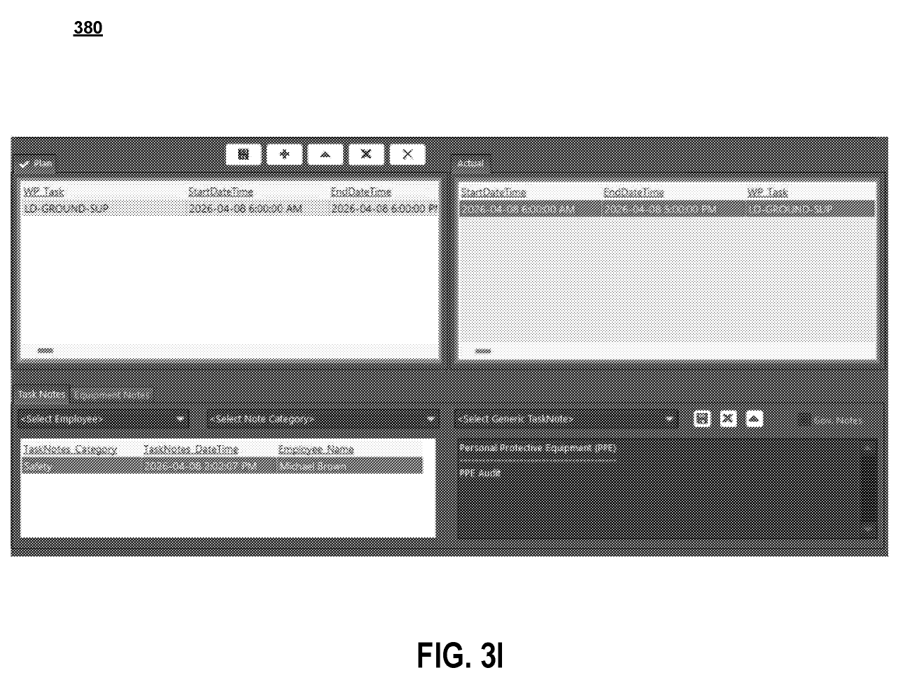

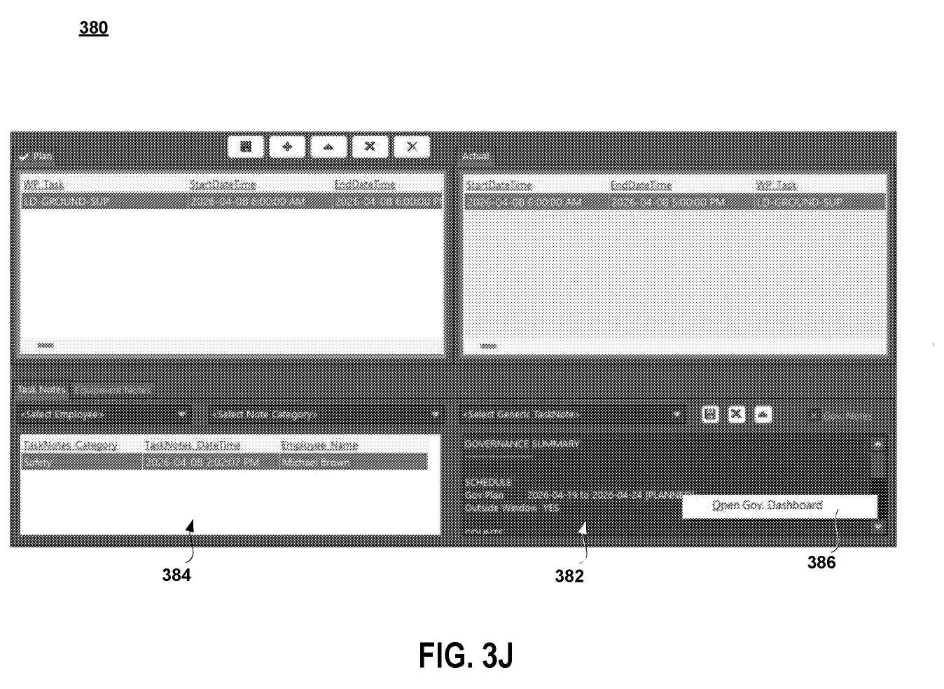

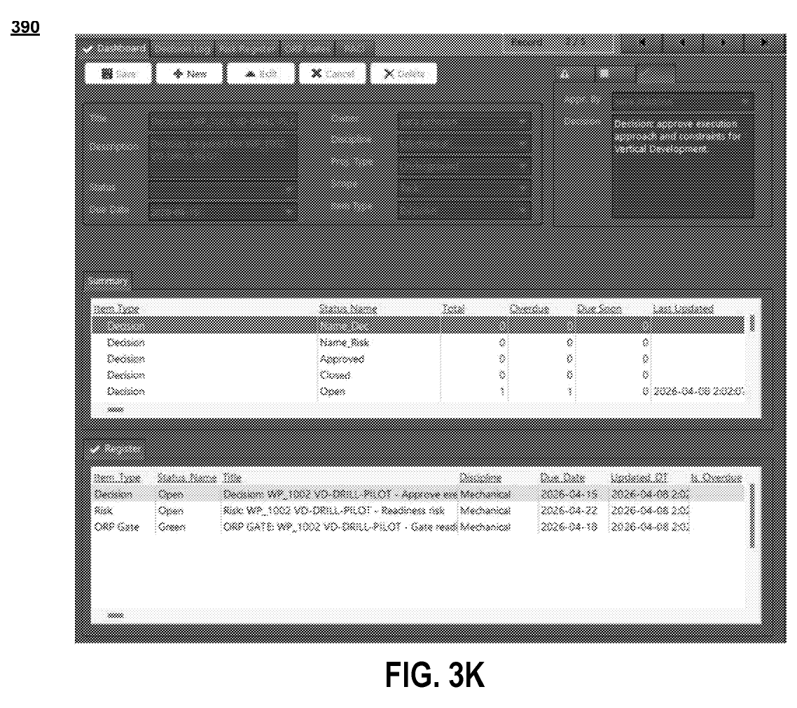

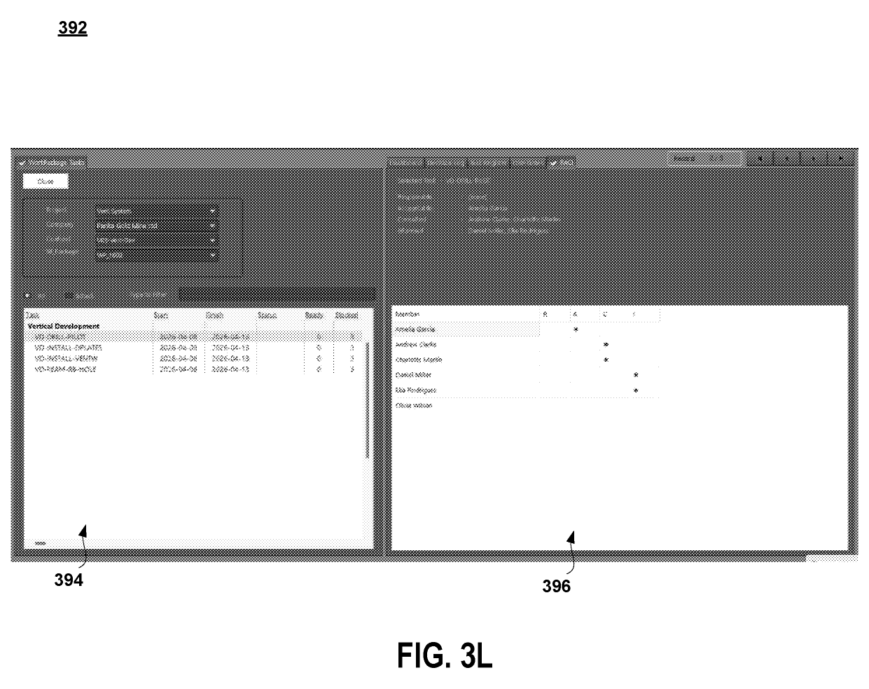

Referring to FIGS. 3A–3L, screenshots are presented showing various illustrative embodiments of the user interface presented by the GUI 120 and of functionality of the system 100 described in FIG. 1.

FIG. 3A shows the RACI chart design interface 300, where users create role assignments for specific work package tasks. The GUI 120 retrieves a list of tasks from the planning engine 140 and allows the user to assign RACI roles—Responsible (R), Accountable (A), Consulted (C), and Informed (I)—to individuals via drop-downs or checklists. In the embodiment of FIG. 3A, RACI roles are assigned, for the tasks listed on the side panel 302 presented by the GUI 120, to “John Smith” whose role is “Project Manager”. In this example, this individual is assigned the “Responsible” role for the task “Loading Dev. Blast”, the “Consulted” role for the tasks “Benching Dev. Round” and “Installation of D-Plates”, and the “Accountable” role for the tasks “IFC Prints” and “Reaming RB hole”. These assignments are stored in the underlying database via the processing device 110 and may be dynamically updated or visualized based on project context.

FIG. 3B shows the task filtering interface 310. Through the GUI 120, users interact with the GUI 120 (e.g., using drop-down menus and/or other suitable user interface elements such as buttons) to apply filters based on Project Members, project name, Company, and Work Package. The filtering parameters are passed to the planning engine 140, which queries the task database via SQL and returns only the records that match both the metadata and, optionally, the review status. This ensures that users see only contextually relevant tasks for planning or review. In the illustrated embodiment, the RACI matrix is filtered to only display (in the side panel 312 presented by the GUI 120) the RACI roles and corresponding tasks (“LD-BLAST-ROUND”) assigned to individual “Grace Robinson”. The interface 314 shows work-package level assignment of roles and tasks, whereby for the work package number “WP_1002”, the individual named “Olivia Wilson” is assigned four (4) tasks and has the role of “Contracts Administrator” (as presented in the side panel 316).

FIG. 3C shows task creation and filtering in a combined interface 320. Users may create new tasks linked to a work package (e.g., “WP-107” in the illustrated embodiment) and Task Category (e.g., “Lateral Development” in the illustrated embodiment) using structured input fields. Tasks can then be filtered using criteria such as deadline, RACI role, or completion status, with the logic handled by the planning engine 140 and results shown on the GUI 120. More specifically filtering can be achieved in the following ways:
Selecting a transmittal number (e.g., “ECN-026”) on the tree-view visual component 332 filters that transmittal into the display grid 334 (FIG. 3D).
Selecting a date (e.g., 2025-05-04) from the drop down date selector 336 filters all transmittals and tasks associated with that date (FIG. 3D).
Selecting a work package (e.g., “WP-107”) in the tree-view visual component 332 filters all transmittals and tasks associated with that work package (FIG. 3D).
Selecting a specific task (e.g., “Benching Dev. Round”) filters the associated transmittal(s), review documents metadata, and review progress (FIG. 3F).

FIG. 3D further illustrates the transmittal creation and categorization interface 330. Here, users generate a new transmittal and associate it with discipline, branch, and revision metadata. The processing device 110 stores the metadata, while the GUI 120 enables users to preview, tag, and organize transmittals for distribution.

FIG. 3E shows the interface 340 for organizing transmittals. Users may drag and drop transmittals between virtual “bins” or file directories 342. These actions trigger file system operations—coordinated by the processing device 110—which create or move files within auto-generated folder (or directory) paths based on metadata (e.g., discipline, branch, revision identifier, timestamp). In particular, the processing device 110 is configured to automatically classify each transmittal into a discipline-based folder structure by automatically generating a plurality of folder paths based on the discipline designation, the branch designation, and the revision identifier, each folder path being associated with a respective transmittal, and to move the transmittal data (i.e. the files) associated with each transmittal into the corresponding folder path. The processing device 110 may be configured to issue one or more Application Programming Interface (API) calls to create the folder paths on a storage medium (when the path does not already exist) and to execute the file move operation to relocate the transmittal files (e.g., from a staging directory) into the created folder paths.

FIG. 3F displays the assignment interface 350 where transmittals and review documents are allocated to specific users. Through the GUI 120, a reviewer is selected and locked to the document using user identity. The system 100 ensures exclusive assignment using access control logic handled by the planning engine 140, which prevents concurrent edits or duplicate reviews. In one embodiment, the access control logic implemented by the planning engine 140 entails reviewer identity-based file locking, whereby a lock record associating a reviewer identifier (of a designated reviewer) with a target document file path is written to memory (e.g. to the relational database) in response to receiving a reviewed file upload event (i.e. receiving a reviewed file from the designated reviewer). The planning engine 140 is configured to intercept any subsequent file access request directed to the target document file path and to compare the requesting user’s identifier against the stored lock record. The planning engine 140 may then only accept the file access request (and grant the requesting user access, e.g. read and write access, to the target document file path) when the requesting user identifier matches the reviewer user identifier in the lock record. The planning engine 140 may reject the file access request when the requesting user identifier does not match the reviewer user identifier in the lock record.

FIG. 3G shows the reviewed document upload interface 360. Users submit annotated documents to the server, and the processing device 110 links the reviewed file to its originating transmittal and stores the file path and metadata in the SQL database. Real-time status updates are triggered for traceability.

FIG. 3H shows an integrated dashboard 370 summarizing shift execution and transmittal status. This dashboard 370, driven by data from the planning engine 140 and stored procedures executed by the processing device 110, provides users with a shift-ready view of pending, completed, or reviewed documents and tasks, enabling seamless shift handovers.

Referring now to FIGS. 3I-3L, the system 100 further enables enhanced integration between execution, governance, and responsibility modeling. This introduces tighter coupling between execution and governance processes, context-aware presentation of governance information during execution, and layered responsibility modeling across planning and execution levels, while maintaining separation between execution interfaces and governance management functionality.

In accordance with one embodiment, the system 100 is configured to determine an execution readiness state associated with one or more work package tasks. The execution readiness state indicates whether a given work package task is capable of safe, compliant, and operationally effective execution within a current operational context.

In one embodiment, the execution readiness state is dynamically determined by the planning engine 140 based on evaluation of one or more operational conditions, governance conditions, environmental conditions, execution dependencies, and/or resource conditions associated with the work package task. The planning engine 140 may continuously evaluate the execution readiness state during planning operations, shift execution operations, governance updates, and/or execution-state changes.

In one embodiment, the planning engine 140 determines the execution readiness state using one or more readiness indicators comprising governance indicators, operational readiness indicators, equipment operational states, workforce qualification states, permit states/conditions, environmental conditions, document approval states, predecessor task completion states (dependency conditions), material availability states, workforce availability states, risk conditions, decision states, operational readiness permit (ORP) conditions, and/or scheduling/operational constraints associated with the work package tasks.

In one embodiment, the execution readiness state may comprise one or more readiness classifications including ready, partially ready, blocked, delayed, governance hold, suspended, awaiting approval, awaiting equipment availability, awaiting workforce availability, and/or not execution-ready states. The planning engine 140 may dynamically update the readiness classification associated with the work package task in response to changes in one or more readiness indicators.

In one embodiment, the system 100 distinguishes between scheduled work and executable work such that a work package task may remain visible within a task schedule while simultaneously being classified as not execution-ready. The planning engine 140 may suppress execution assignment of the work package task, dynamically reprioritize the work package task, initiate escalation workflows, generate notifications to designated personnel, require governance acknowledgements, and/or trigger governance review actions in response to determining that the work package task is not execution-ready. In one embodiment, one or more escalation notifications are generated (e.g., by the planning engine 140) in response to determining that one or more governance indicators associated with at least one work package task exceed a predefined operational threshold or remain unresolved beyond a predefined operational condition.

In one embodiment, the planning engine 140 continuously reconciles (i.e. compares) planned/scheduled operational state with observed execution state to identify discrepancies between planned/scheduled operational readiness and actual field execution readiness. The reconciliation may be performed using execution observations, governance updates, equipment status changes, workforce updates, environmental changes, and/or execution feedback received during shift execution operations. In this manner, the system 100 maintains continuous operational alignment between planning activities, execution activities, and governance conditions associated with mining operations.

FIG. 3I shows a shift-based execution interface 380, in accordance with one embodiment. The shift-based execution interface 380 may be provided by the system 100 as part of the GUI 120 to manage execution activities within defined shift periods and present execution readiness state information associated with the work package tasks. The shift-based execution interface 380 may be used to aggregate execution data (e.g., obtained from execution record(s) retrieved from a central database) comprising planned tasks, actual completed tasks, observation notes, and equipment context (i.e. equipment-related data). In the illustrated example, the shift-based execution interface 380 is used to display execution data for the “LD-GROUND-SUP” work package.

Referring now to FIG. 3J, in accordance with one embodiment, when a work package task is selected via the GUI 120, the system 100 dynamically retrieves, from one or more stored governance records, governance data (i.e. governance indicators, also referred to herein as “governance context”) associated with the selected work package task and presents a Governance Summary within a sub-region 382 (e.g., the bottom right area) of the execution interface 380. The Governance Summary provides governance context within execution and enables execution activities to be evaluated in association with governance state and execution readiness state.

In one embodiment, the dynamically retrieved governance context comprises one or more governance indicators associated with the selected work package task including governance schedule windows, outside-window indicators, operational readiness indicators, execution readiness indicators, open risks, blocked items, decision states including overdue decision conditions, permit conditions, document approval states, operational readiness permit (ORP) conditions, equipment readiness conditions, environmental constraints, gate conditions, acknowledgment requirements, escalation states, and/or dependency-related constraints associated with the selected work package task.

In one embodiment, the system 100 automatically filters the retrieved governance data based on execution context associated with the selected work package task such that only governance indicators relevant to current execution activities are presented within the execution interface 380. The governance indicators may be dynamically updated in response to execution-state changes, governance-state changes, equipment-state changes, shift-transition events, environmental-condition changes, and/or operational feedback received during execution activities.

In one embodiment, the governance context presented within the execution interface 380 influences execution readiness determination, execution visibility, execution prioritization, operational escalation behavior, governance review actions/interaction behavior, and/or execution assignment availability associated with the selected work package task. The system 100 may distinguish between scheduled work and executable work based on the presented governance context and associated execution readiness state.

In one embodiment, the governance data is presented within the execution interface 380 without enabling direct modification by the user from within the Governance Summary region, thereby preserving separation between execution interaction workflows and governance management workflows while maintaining contextual visibility of governance conditions during execution activities.

Still referring to FIG. 3J, in accordance with one embodiment, the system 100 further allows users to manage activities within execution. For instance, observations and equipment notes may be provided in a sub-region 384 (e.g., the bottom left area) of the execution interface 380. In the illustrated embodiment, the notes relate to the safety category of the “LD-GROUND-SUP” work package. It should be understood that the positioning (e.g., top, bottom, left, right) of the various regions of the interfaces (e.g., sub-regions 382, 384 of interface 380) as described herein may vary.

FIG. 3K shows a user interface 390 for execution to governance navigation via the GUI 120, in accordance with one embodiment. The system 100 is configured to provide interaction control(s) or element(s) (e.g., click button 386 of FIG. 3J) that enable navigation from the execution interface (reference 380 in FIGS. 3I and 3J) and allow the user to open the governance management interface 390 separate from the execution interface 380. The governance management interface 390 is automatically pre-filtered to the selected work package task and, optionally, associated governance item(s), thereby reducing memory consumption and ensuring that the governance data presented via the GUI 120 reflects the real-time database state.

In addition, the system 100 may be configured to establish an execution-governance feedback loop in which execution data, observations, and equipment context inform governance state and governance indicators inform execution decisions. This may, in turn, enable continuous alignment between planning, execution, and governance processes. For this purpose, in response to a write event updating an execution record, the processing device 110 may be configured to execute a trigger procedure that propagates updated field value(s) from the execution record to a governance record linked to the execution record (i.e. by writing the updated field value(s) into the corresponding governance field) via a foreign key relationship. The foreign key relationship may be structured to index governance records at the work package task level, such that a change to an execution record causes an update to the governance record(s) specifically indexed to the corresponding work package task. Additionally, in response to a change in a governance indicator field of a governance record linked to a work package task, the processing device 110 may be configured to execute a scheduling adjustment procedure which, based on the changed governance indicator, modifies task priority value(s) and/or reorders task execution sequences in the task schedule (as generated by the planning engine 140) for the linked work package task. In this manner, a bidirectional data propagation path between the execution record store and the governance record store can be established without requiring user-initiated synchronization. The bidirectional propagation may operate through database-level trigger procedures rather than through application-layer polling or user-driven refresh operations. Each trigger-initiated update may be recorded in a log table with a source record identifier, a target record identifier, a field name, a previous value, and a new value. The log table may thus provide an auditable history of all automatic cross-store updates.

FIG. 3L shows a user interface 392 for RACI assignment with execution context, in accordance with one embodiment. In this case, a multi-level RACI assignment model is implemented, with the RACI assignments being supported at both the work package level (i.e. strategic responsibility) and the task level (i.e. execution responsibility). For this purpose, the RACI assignments are determined based on responsibility assignment records (e.g., retrieved from a central database) comprising task-level responsibility assignments and work package-level responsibility assignments. In the illustrated example, the “WP_1002” work package and tasks “VD-DRILL-PILOT”, “VD-INSTALL-DPLATES”, “VD-INSTALL-VENTW”, and “VD-REAM-RB-HOLE” are listed in a sub-region 394 (e.g., left) of the interface 392, with RACI assignments for any selected task (e.g., for task “VD-DRILL-PILOT”) being displayed in a sub-region 396 (e.g., right) of the interface 392. Task-level responsibility assignments may inherit one or more responsibility attributes from the work package-level responsibility assignments and may have responsibility attribute(s) overridden based on execution context. Assignments may be filtered across project, company, contract, work package, and task category.

While platforms like Aconex^{TM} and Bluebeam^{TM} are used in construction and infrastructure projects, they often fall short in mining environments where day-to-day shift execution depends on tight timing, traceability, and discipline-specific structure. Aconex^{TM} requires manual folder setup or templates, lacks native shift-based visibility, and often forces teams to work through web interfaces not optimized for underground access. Bluebeam^{TM} focuses on markup, rather than file lifecycle tracking. In contrast, the systems and methods described herein are built from the ground up for mining applications, where engineering data, operational feedback, and execution planning flow in sync, not in silos. Whether the hardware facility is underground or in the office, the systems and methods described herein provide the team the right data, at the right time, in the right format.

The approach described herein focusses on optimizing workflows, managing transmittals, RACI roles, shift activities, and integrating reporting. Its focus also includes digitizing, streamlining, and bringing accountability to mining operations.

Below is an example operational scenario illustrating execution readiness determination, governance-aware execution coordination, contextual responsibility assignment, and shift-based operational continuity, in accordance with one embodiment.
Using Shifter’s Notebook to Coordinate Execution Operations
1. Morning Planning and Execution Readiness Evaluation (Shift Line-Up)
At approximately 6:00 AM, the shift supervisor opens Shifter’s Notebook and filters the workplan for Development activities scheduled for Levels 420 and 450 during the current shift period. The planning engine 140 retrieves scheduled work package tasks, execution-state information, governance indicators, execution readiness indicators, equipment operational states, workforce availability states, and associated transmittal information for the selected work areas.
In one embodiment, the planning engine 140 determines execution readiness states associated with the scheduled work package tasks. The planning engine 140 identifies that the 450-02E heading requires one production round to be drilled and blasted, while ground support installation activities (bolting and screen installation) remain incomplete in 420-03W. The planning engine 140 further determines that SCOOP-07 was flagged for mechanical repair during the previous shift and that a ventilation inspection approval associated with 420-03W remains unresolved.
In one embodiment, the planning engine 140 determines that although the 420-03W work package remains scheduled, the work package is currently classified as not execution-ready due to unresolved governance conditions and incomplete prerequisite activities. The planning engine 140 dynamically suppresses active execution assignment for the affected work package task and generates a governance notification identifying the unresolved readiness conditions.
2. Contextual RACI Assignment and Governance Coordination
In one embodiment, the planning engine 140 automatically retrieves contextual RACI assignments associated with the selected work package tasks. The system determines that John is Responsible for execution activities associated with the 450-02E heading, Mario is Accountable for ensuring explosive delivery readiness, the mechanical supervisor is designated as Consulted for SCOOP-07 repair approval, and the safety officer is designated as Informed for ground support activities associated with a nearby historical fall-of-ground zone.
In one embodiment, the planning engine 140 dynamically modifies notification routing and escalation behavior based on execution readiness state and governance indicators associated with the selected work package tasks. The unresolved ventilation approval associated with 420-03W triggers an escalation notification to the Accountable and Consulted users associated with the affected work package.
3. Governance-Aware Review of Transmittals and Engineering Documents
Shifter’s Notebook retrieves transmittal data and review-state information associated with the selected work package tasks. The system identifies that revised ground support installation drawings associated with 420-03W were uploaded and reviewed during the previous shift period. The planning engine 140 confirms that drawing “GS-420W-Rev2” is currently classified as “Reviewed by Engineering” and determines that the reviewed document satisfies one of the execution readiness conditions associated with the work package task.
In one embodiment, the processing device 110 automatically validates document review status, revision state, and discipline-based file availability before permitting execution release of associated work package tasks.
4.Dynamic Shift Card and Execution Coordination Generation
In one embodiment, the system 100 automatically generates personalized execution coordination summaries and shift cards for designated personnel based on execution role, governance context, execution readiness state, equipment context, and assigned work package tasks. Drillers receive drilling instructions, geotechnical notes, blast sequencing information, and readiness constraints associated with the 450-02E heading. Bolters receive bolt-pattern installation details, screened-heading status information, and governance-related safety acknowledgements associated with the 420-03W work package. Mechanics receive equipment task summaries associated with SCOOP-07 including fault-code information, inspection history, readiness conditions, and operational release requirements.
In one embodiment, work package tasks classified as not execution-ready are excluded from active execution assignment lists while remaining visible within planning and governance interfaces.
5. Field Execution, Readiness Reconciliation, and In-Shift Operational Updates
During shift execution operations, execution-state updates are continuously received from field personnel. Bolters use a mobile computing device to submit completion status information and field observations associated with completed support installation activities. Mechanics update SCOOP-07 from a maintenance state to an operationally ready state at approximately 10:40 AM. The shift supervisor records that the 450-02E heading was drilled by approximately 11:15 AM and is ready for explosive charging operations.
In one embodiment, the planning engine 140 continuously reconciles planned operational state with observed execution state using field execution updates, governance-state changes, equipment-state changes, and execution observations. Upon determining that ventilation approval conditions associated with 420-03W have been resolved and that prerequisite support activities are complete, the planning engine 140 dynamically updates the execution readiness state associated with the affected work package task from not execution-ready to ready for execution.
6. Shift-End Operational Summary and Governance Traceability
At approximately 6:00 PM, Shifter’s Notebook automatically generates a shift-end operational summary comprising completed work package tasks, scheduled-versus-executed task comparisons, execution readiness history, equipment downtime events, governance acknowledgements, unresolved operational blockers, execution escalation events, and contextual RACI activity records associated with the completed shift period.

In one embodiment, the generated operational summary includes governance-state transitions, readiness-state changes, execution suppression events, and responsibility acknowledgements associated with the work package tasks, thereby preserving operational continuity between shifts and maintaining an auditable operational history associated with mining execution activities.

From the above, it can be seen that, in some embodiments, the systems and methods described herein may improve operational coordination by dynamically distinguishing between scheduled work and executable work, integrating governance context directly within execution activities, preserving contextual operational continuity across shifts, and reducing execution ambiguity associated with mining operations. The systems and methods may further improve operational accountability through contextual RACI coordination, governance-aware execution management, readiness-based execution control, and centralized execution-governance traceability.

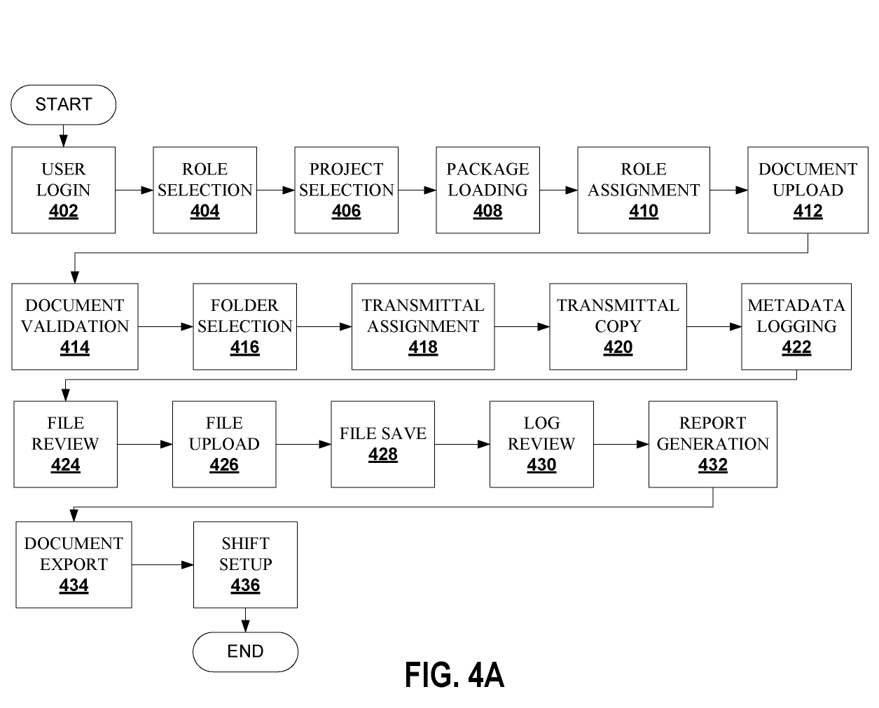

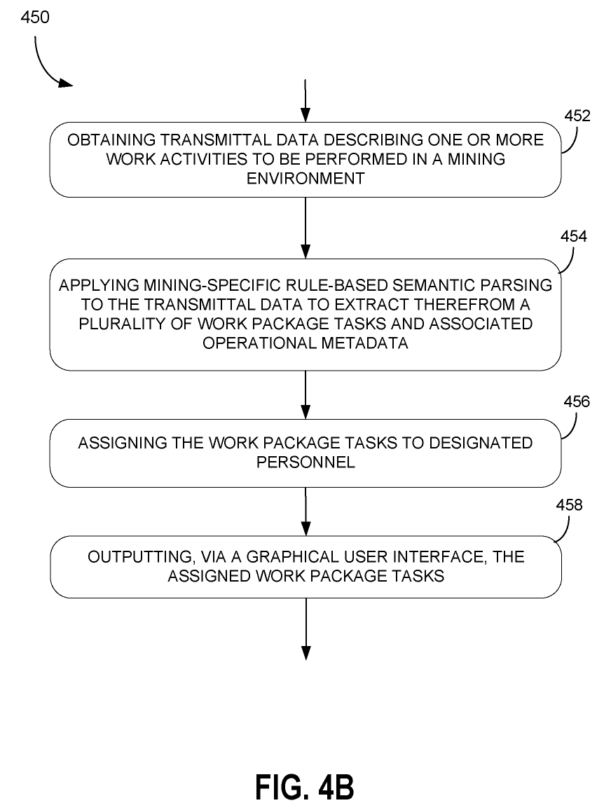

FIG. 4A is a flowchart of a method 400 for mining operations execution, in accordance with one embodiment. The method 400 may be implemented using the system 100 of FIG. 1. In one embodiment, the method 400 may be performed using SQL server backend coupled with FireDAC^{TM} connectivity, a Visual Component Library (VCL)-based GUI implemented in Embarcadero^{TM} C++ Builder^{TM}, document assignment, review and logging modules and an integrated folder structure and file copy operations based on discipline, branch and transmittal number. As referred to herein, “discipline” and “branch” are metadata categories used to organize documents in structured folders (e.g., Mechanical / Shaft Services). As referred to herein, a “C++ Builder FireDAC^{TM}” is a data access framework in Embarcadero^{TM} C++ Builder^{TM} that provides high-performance connectivity to databases including SQL Server, supporting live bindings, transactions, and parameterized queries. Also, as referred to herein, a “VCL” is a set of visual and non-visual components used to design GUIs in Delphi^{TM} and C++Builder^{TM}.

The method 400 starts at step 402, where a user logs into the system 100 (via the GUI 120) using their unique credentials (e.g., username and password).

At step 404, the user determines a role via the GUI 120. The role may be, for instance, an administration, an engineer or a reviewer.

At step 406, the user selects a type of project via the GUI 120.

As used herein, the term “project” refers to a defined scope of engineering or operational work within a mining environment, typically governed by a budget, timeline, and set of deliverables. Projects may include, but are not limited to, underground development (e.g., level expansion, ramp access), infrastructure upgrades (e.g., ventilation raises, pump installations), or production-focused work (e.g., stopping sequences). Each project in the system is uniquely identified and may span multiple work areas, disciplines, or shifts. A project acts as a high-level container under which work packages and tasks are grouped, tracked, and reported.

At step 408, the processing device 110 receives the information inputted by the user via the GUI 120 (e.g., transmittal data obtained from a central database), loads a work package (e.g., following a data parsing procedure by data parsing engine 130), and provides the latter to the planning engine 140. The work package may include RACI creation and assignment tasks, for instance.

As used herein, the term “work package” refers to a discrete, manageable unit of work associated with a specific aspect of a project. A work package includes a specific set of tasks (referred to herein as “work package tasks”) having defined scope, resources, schedule, and deliverables associated therewith. Each work package task has one or more parameters associated therewith, the parameter(s) comprising a task description, required worker qualification(s), resource requirement(s), deadline(s), and a cost estimate. In mining operations, work packages may include, but are not limited to, production work packages (e.g., a drill and blast work package including tasks such as defining drill pattern execution, loading explosives, blast initiation), haulage work packages (e.g., an ore hauling work package including tasks such as loading trucks at shovel, transporting ore to a crusher, dumping at a designated location), maintenance work packages (e.g., including tasks such as inspecting engines, replacing parts), and a development work package (e.g., including tasks such as drilling, blasting, ventilation setup, and ground support installation). For example, this may include task groupings such as “Install Primary Ground Support – 420 Level” (referring to activities to stabilize newly excavated tunnels or openings at the 420 level, i.e. 420 meters below surface), “Drill Vent Raise Bypass” (referring to activities to drill an alternative passage associated with a ventilation raise), or “Service Crusher Conveyor” (referring to activities to perform maintenance work on a conveyor associated with a crusher). A work package includes detailed information such as location (level, heading), discipline (e.g., electrical, mechanical, ground support), estimated resources, required materials, and associated transmittals or drawings. Work packages are the operational building blocks that structure daily shift planning. In operation, work packages may be used to assign crews and equipment, track completion of tasks, and monitor productivity and output. In governance, work packages may be used for budget allocation, risk assessment, performance tracking, and reporting and accountability.

At step 410, the planning engine 140 assigns roles, such as RACI roles, for a plurality of tasks based on the work package.

In one scenario, role assignment is performed at step 410 using a pre-configured RACI matrix stored in the SQL database. Each WorkPackageTask record includes foreign keys linking it to both a work package and a set of assigned users. The system 100 uses predefined rules (or administrator-configured policies) to assign RACI roles based on task characteristics such as (but not limited to) Discipline (e.g., mechanical tasks go to the mechanical supervisor by default), Project or Work Package type, Branch/crew and Historical assignments or user workloads.

When a new task is created (either manually or parsed from a transmittal), the planning engine 140 queries the RACI table to determine which users fulfill each role. In particular, the Responsible user is typically the person executing the task (e.g., a driller or technician), the Accountable user is the supervisor responsible for ensuring task completion, the Consulted user may be an engineer or safety officer who must review or approve certain components, and the Informed user may be a stakeholder that should be kept updated on progress, decisions, or completion of the task but is not directly involved in the work.

At step 412, the processing device 110 receives (from the planning engine 140) a document including the tasks and uploads the latter on a server.

At step 414, the processing device 110 validates and classifies the document including the tasks.

At step 416, the processing device 110 moves to the discipline and branch folder.

At step 418, the processing device 110 assigns the tasks to a given transmittal.

At step 420, the processing device 110 copies the tasks in the assigned transmittal folder.

At step 422, the processing device 110 logs metadata associated with the assigned transmittal in a SQL server.

At step 424, the processing device 110 provides files related to the assigned transmittal to a reviewer.

At step 426, the processing device 110 receives a reviewed file from the reviewer and uploads the reviewed filed to the server. The reviewed file may, for instance, be the assigned transmittal signed by the reviewer.

At step 428, the processing device 110 saves the reviewed file in a review folder of a local memory.

At step 430, the processing device 110 logs the reviewed file in a database.

At step 432, the processing device 110 generates one or more operational reports based on the reviewed file, execution-state information, governance indicators, readiness-state information, responsibility assignment data, and/or transmittal metadata associated with one or more work package tasks. In one embodiment, the operational reports comprise SQL Server Reporting Services (SSRS)-generated execution summaries, governance summaries, readiness-state summaries, shift-transition summaries, escalation reports, audit reports, and/or responsibility traceability reports associated with mining operations execution activities.

At step 434, the processing device 110 exports, synchronizes, archives, and/or distributes the generated operational reports to one or more local memories, archive databases, centralized servers, remote computing devices, mobile computing devices, and/or shift-based operational interfaces. In one embodiment, the exported operational reports preserve execution context, governance context, readiness-state information, execution-state history, and responsibility assignment history associated with the work package tasks such that operational continuity is maintained across shift transitions and distributed operational teams.

At step 436, the processing device 110 coordinates and integrates work package assignments, governance conditions, execution readiness states, transmittal information, and responsibility assignment data to establish shift-based execution coordination for one or more mining operations activities. In one embodiment, the processing device 110 dynamically distinguishes between scheduled work package tasks and executable work package tasks based on execution readiness determination and governance-state evaluation associated with the work package tasks.

FIG. 4B is a flowchart of a method 450 for mining operations execution, in accordance with another embodiment. The method 450 may be implemented using the system 100 of FIG. 1. At step 452, transmittal data describing one or more work activities to be performed in a mining environment is obtained by the processing device 110. Step 454 comprises applying, by the data parsing engine 130, mining-specific rule-based semantic parsing to the transmittal data to extract therefrom a plurality of work package tasks and associated operational metadata. Each work package task may have one or more deadlines, task descriptions, required worker qualifications, resource requirements, dependency conditions, governance indicators, readiness indicators, execution constraints, and/or cost estimates associated therewith.

Step 456 comprises assigning, by the planning engine 140, the work package tasks to designated personnel based on execution context associated with the work package tasks. In one embodiment, the planning engine 140 evaluates execution readiness state, governance conditions, workforce availability conditions, equipment operational states, document approval states, environmental constraints, operational readiness permit (ORP) conditions, and/or predecessor task completion states associated with the work package tasks prior to generating execution coordination outputs.

In one embodiment, the planning engine 140 dynamically suppresses, reprioritizes, escalates, or modifies execution assignment of one or more work package tasks in response to determining that the one or more work package tasks are not execution-ready. The assigned work package tasks, associated governance context, execution readiness state information, and execution coordination data are then output, by the processing device 110, via the GUI 120 at step 458.

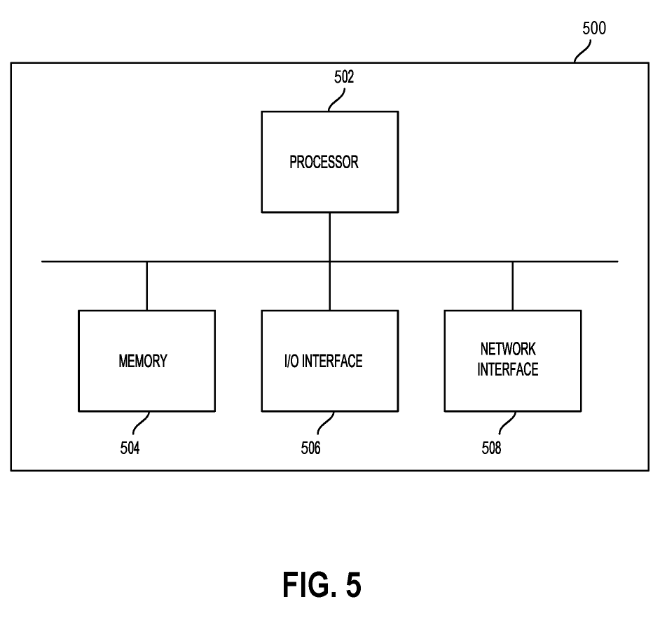

FIG. 5 is a schematic diagram of a computing device 500, which may be used for implementing the mining operations management system 100 of FIG. 1 and/or the methods 400 and 450 of FIGS. 4A and 4B described herein. The computing device 500 comprises at least one processor 502, memory 504, at least one input/output (I/O) interface 506, and at least one network interface 508. In one embodiment, the computing device 500 executes one or more operational coordination processes including execution readiness determination processes, governance-context retrieval processes, responsibility assignment processes, execution-state reconciliation processes, transmittal synchronization processes, and/or execution-governance feedback processes associated with mining operations execution.

Processor 502 may comprise one or more microprocessors, microcontrollers, digital signal processors (DSPs), field-programmable gate arrays (FPGAs), application-specific integrated circuits (ASICs), and/or other programmable or reconfigurable processing devices configured to execute machine-readable instructions associated with operational coordination, governance evaluation, execution readiness determination, contextual filtering, responsibility assignment, and/or execution-state synchronization.

Memory 504 may comprise Random Access Memory (RAM), Read-Only Memory (ROM), Electrically Erasable Programmable Read-Only Memory (EEPROM), Ferroelectric RAM (FRAM), flash memory, magnetic storage, solid-state storage, and/or other computer-readable media configured to store operational data, governance records, execution-state information, transmittal metadata, responsibility assignment records, and executable program instructions associated with mining operations execution activities.

Each I/O interface 506 enables computing device 500 to interconnect with one or more input devices, such as a keyboard, mouse, camera, touch screen and a microphone, or with one or more output devices such as a display screen and a speaker.

Each network interface 508 enables computing device 500 to communicate with other components, to exchange data with other components, to access and connect to network resources, to serve applications, and perform other computing applications by connecting to a network (or multiple networks) capable of carrying data.

Compared to existing systems and methods, the system and methods described herein may, in some embodiments, provide a solution that is cost effective, less capital intensive, and more user friendly. Key benefits of the embodiments described herein may comprise, but are not limited to, identifying and scheduling work for each shift, preparing personalized shift cards for each worker on shift, facilitating easy access to shift change data, processing and decision making, start and end of shift reporting, sharing information with shift coordinators at the end of the shift, and ease of installation and use. Additionally, the systems and methods described herein do not require extensive upfront capital, including extensive operator training.

The systems and methods described herein provide a centralized, purpose-built software solution designed to streamline operational tracking, document control, and role-based accountability in mining environments. The platform addresses long-standing inefficiencies in shift-based coordination, transmittal tracking, and review workflows across multidisciplinary teams. In one embodiment, the system leverages an SQL Server backend integrated with a C++Builder™ front end, providing a responsive and robust desktop interface for recording shift activities, assigning RACI roles, and managing document lifecycle states. The platform also integrates SQL Server Reporting Services (SSRS) to deliver dynamic, filterable reports that enhance real-time visibility into task status, review state, and crew accountability.

Conventional scheduling systems primarily represent planned operational state and generally do not continuously reconcile planned work against dynamically changing field execution readiness conditions. In contrast, the system described herein maintains contextual execution readiness state information associated with work package tasks and dynamically modifies execution visibility, execution prioritization, governance interaction behavior, and/or execution assignment availability based on changing field conditions, governance-state changes, execution observations, operational constraints, and readiness-related conditions associated with mining operations activities.

The system described herein offers significant computational advantages over conventional enterprise platforms. Unlike generalized web-based document control systems that rely on continuous server polling, browser rendering, or cloud-side computation, the system described herein performs task assignment, metadata parsing, and folder management locally via compiled desktop code. This architecture, which is optimized for resource-constrained mining environments with limited bandwidth or intermittent connectivity, reduces system latency, speeds up user interaction, and minimizes server load. Additionally, the use of structured SQL queries and indexed lookup tables significantly improves data retrieval efficiency, enabling near-instant access to filtered workplans, role-based task views, and document history even within large-scale operational datasets.

By bridging the gap between engineering documentation and field execution through an optimized and scalable architecture, the systems and methods described herein enable better decision-making, reduce downtime during shift transitions, and provide a measurable improvement in both human and computational efficiency across mining operations.

In some embodiments, the systems and methods described herein provide several improvements over existing document control tools: real-time filtering of transmittals based on SQL metadata and physical file presence, without reliance on manual logs, integrated review tracking that links file system state (e.g., directory) with database metadata, exclusive review enforcement using reviewer identity-based file locking, auto-generation of structured folder paths using metadata (e.g., discipline, branch, revision) and creation of shift-tailored review summaries, delivering only relevant feedback to the next shift team.

Furthermore, in some embodiments, the task-level integration of execution and governance, context-aware governance visibility, multi-level RACI modeling, execution-governance feedback loop, and context-preserved interaction implemented by the systems and methods described herein provide advantages over conventional scheduling, project management, and governance tools.

First, in widely used scheduling and project management systems (e.g., Primavera P6, Microsoft Project), execution tracking focuses on tasks, durations, and progress updates. Governance elements such as risks and decisions are typically managed in separate modules, reports, or external tools. Users generally review governance information independently of day-to-day task execution. In contrast to existing systems, in the system described herein, when a user selects a specific work package task within the execution interface, the system dynamically retrieves and presents governance context (such as risks, decisions, and readiness indicators) associated with the selected task including governance indicators influencing execution readiness state. This allows execution activities to be directly informed by governance state without requiring the user to navigate to a separate module.

Second, in many construction and project platforms (e.g., Procore, Aconex), governance-related information is accessible through dashboards or logs (e.g., risk registers, Request for Information (RFI) logs, transmittals). These views are typically static or require manual filtering and are not inherently tied to a specific execution moment. In contrast, in the system described herein, governance information is context-aware and automatically filtered based on the selected work package task. The system presents only the governance elements relevant to the current execution context (i.e. a subset of governance indicators specific to the selected work package task), enabling users to assess risk and decision status at the point of execution.

Third, traditional systems often assign responsibility at a single level (for example, assigning an owner to a task or associating roles at the project level). While some systems allow role assignments, they generally do not distinguish between strategic accountability and task-level execution responsibility in a structured way. In the system described herein, responsibility assignments are applied at both the work package level and the task level. Task-level assignments may inherit from work package-level assignments and be overridden based on execution context (e.g., discipline, crew, or activity type). This supports separation between strategic accountability and operational responsibility within the same framework.

Fourth, in conventional tools, updates to execution (e.g., progress or field notes) and updates to governance (e.g., risks or decisions) are often recorded independently, with limited structured interaction between them. In the system described herein, execution data (including observations, equipment context, and task updates) can inform governance records, while governance indicators influence execution decisions. This establishes a feedback loop that continuously aligns execution with governance state.

Fifth, in existing systems, users typically navigate between execution views and governance dashboards manually. For example, a user may identify an issue in a schedule, then separately open a risk register or decision log, often losing the original context. In the system described herein, the user can initiate a governance management interface directly from the execution interface, with the system automatically filtering the governance view to the selected work package task and associated items. This preserves context and reduces the need for manual cross-referencing.

In summary, while existing systems provide capabilities in scheduling, document management, and governance tracking, they generally treat execution and governance as separate or loosely connected functions. The system described herein integrates these functions by dynamically associating governance context with execution activities at the task level, supporting context-aware visibility of governance data during execution, and enabling layered responsibility modelling across planning and execution levels, thereby providing a more tightly coupled execution–governance framework.

At least the features described above represent changes to the manner in which the system actually operates, specifically the manner in which execution data, governance information, and responsibility assignments are connected. This, in turn, improves the functioning of the computer(s) used to manage and execute mining operations. Existing project management and governance systems are typically adjusted by adding custom fields, introducing additional workflows, configuring dashboards or reports, or linking modules through manual navigation or basic integration. In typical systems, execution data, governance information, and responsibility assignments are managed separately and linked through manual navigation or reporting. In contrast, the system described herein integrates these elements at the task level and updates them dynamically based on the current execution context and implementing these features requires changes to the underlying data relationships and system behavior.

In particular, having regard to task-level integration of governance context, conventional systems do not natively associate governance data (e.g., risks, decisions, readiness indicators) directly with execution activities at the task level in a dynamic and context-aware manner. Implementing such behavior requires restructuring the manner in which governance records are indexed, retrieved, and associated with execution data.

Having regard to context-aware retrieval and presentation, the system described herein dynamically retrieves governance data based on the currently selected work package task and presents it within the execution interface. This differs from typical dashboard filtering or reporting, as it requires real-time contextual binding between execution state and governance data, rather than static or user-driven filtering.

Having regard to multi-level responsibility modelling, the support for both work package-level and task-level RACI assignments, including inheritance and override behavior, introduces a layered responsibility model that is not typically supported through standard role or permission configurations. Achieving this behavior requires modifications to underlying data structures and assignment logic.

Having regard to the execution-governance feedback loop, the system described herein establishes a feedback mechanism in which execution data contributes to governance state, and governance indicators influence execution decisions. This bidirectional relationship differs from conventional systems, where execution tracking and governance management are typically maintained as separate or loosely connected processes.

Finally, having regard to context-preserved interaction between interfaces, the ability to transition from execution views to governance management interfaces with preserved context (e.g., filtered to a specific task and associated governance items) requires coordinated behavior across multiple system components. This is not equivalent to standard navigation or linking between modules.

The combined implementation of the above-mentioned features therefore requires coordinated changes across data models, retrieval logic, user interaction patterns, and responsibility structures. Accordingly, the system described herein reflects a distinct and improved approach to integrating execution and governance processes.

As will be understood by a skilled person, the instant disclosure also relates to combinations of the above embodiments and aspects of the systems and methods described herein.

As will be understood by a skilled person, other variations and combinations may be made to the various embodiments of the systems and methods as described herein above.

The present description refers to a number of documents, the content of which is herein incorporated by reference in their entirety.

The scope of the claims should not be limited by the preferred embodiments set forth in the examples; but should be given the broadest interpretation consistent with the description as a whole.

1. A computer-implemented method for mining operations execution, the method comprising:
obtaining, at a processing device, transmittal data describing one or more work activities to be performed in a mining environment;
applying, by a data parsing engine operatively coupled to the processing device, mining-specific rule-based semantic parsing to the transmittal data to extract therefrom a plurality of work package tasks, each work package task having at least one of a deadline, a task description, at least one required worker qualification, a resource requirement, and a cost estimate associated therewith;
assigning, by a planning engine operatively coupled to the data parsing engine and to the processing device, each work package task to designated personnel; and
outputting, by the processing device and via a graphical user interface, the plurality of work package tasks as assigned.

2. The method of claim 1, further comprising, at the processing device:
querying a central database with a selected one of the plurality of work package tasks, the central database having stored therein a plurality of execution records comprising execution data indicative of at least one of planned tasks, actual completed tasks data, observation data, and equipment-related data;
obtaining, based on the querying, execution data for the selected work package task; and
rendering, within an execution interface of the graphical user interface, the execution data in association with the selected work package task.

3. The method of claim 2, further comprising, at the processing device:
querying the central database with the selected work package task, the central database having further stored therein a plurality of governance records comprising a plurality of governance indicators indicative of at least one of a task schedule status, a risk status, a decision status, and an operational readiness status;
automatically filtering, based on the querying, the plurality of governance indicators to obtain a subset of governance indicators specific to the selected work package task; and
rendering the subset of governance indicators within the execution interface along with the execution data.

4. The method of claim 3, further comprising, at the processing device:
receiving user input in response to a user interacting with at least one interface element provided in the execution interface; and
generating, based on the user input, a governance interface separate from the execution interface, the governance interface presenting the subset of governance indicators in association with the selected work package task.

5. The method of claim 4, further comprising, at the processing device:
establishing a bidirectional propagation path between the plurality of execution records and the plurality of governance records; and
in response to receiving a write event updating an execution record or a governance record, propagating, via the bidirectional propagation path, updated field values from the execution record or the governance record respectively into a corresponding governance record or a corresponding execution record.

6. The method of claim 5, further comprising, at the planning engine,:
execution readiness state associated with each one of the plurality of work package tasks based on one or more governance indicators, equipment operational states, workforce availability states, permit conditions, document approval states, environmental conditions, dependency conditions, operational readiness permit (ORP) conditions, and/or operational constraints associated with the plurality of work package tasks;
continuously comparing a scheduled operational state associated with the plurality of work package tasks against an observed execution state associated with the plurality of work package tasks to identify discrepancies between a planned operational readiness and an actual field execution readiness; and
dynamically modifying execution visibility, execution prioritization, execution assignment availability, governance interaction behavior, and/or operational escalation behavior associated with one or more work package tasks based on the execution readiness state.

7. The method of claim 6, wherein the planning engine dynamically updates the execution readiness state associated with at least one work package task in response to execution-state changes, governance-state changes, equipment-state changes, workforce-state changes, and/or environmental-condition changes associated with mining operations activities.

8. The method of claim 6, wherein the planning engine:
suppresses execution assignment of at least one work package task determined to be not execution-ready;
generates one or more escalation notifications in response to governance indicators exceeding a predefined operational threshold or remaining unresolved beyond a predefined operational condition;
preserves execution context information across one or more shift transitions to maintain operational continuity associated with incomplete, delayed, blocked, or reassigned work package tasks between shifts; and
maintains visibility of the work package task within a task schedule while selectively restricting execution assignment availability based on the execution readiness state.

9. The method of claim 1, wherein the data parsing engine applies the mining-specific rule-based semantic parsing to the transmittal data by:
applying a tokenizer to segment the transmittal data into discrete lexical units;
matching the discrete lexical units against a dictionary of mining-specific keywords; and
extracting the plurality of work package tasks based on the matching.

10. The method of claim 6, wherein the planning engine is configured to execute a constraint-satisfaction algorithm to evaluate the plurality of work package tasks against a multi-dimensional constraint set comprising one or more safety-based task sequencing constraints, one or more equipment operational readiness conditions, and/or one or more temporal shift-boundary alignment constraints.

11. The method of claim 1, wherein the planning engine assigns each work package task to the designated personnel by querying a pre-configured role assignment matrix stored in a relational database, the role assignment matrix comprising a plurality of role assignment records defining a plurality of user roles for the plurality of work package tasks.

12. The method of claim 11, wherein the plurality of role assignment records comprise work package-level role assignments and task-level role assignments, further wherein the role assignment matrix is a Responsible, Accountable, Consulted, and Informed (RACI) matrix defining a plurality of user roles comprising a Responsible user role, an Accountable user role, a Consulted user role, and an Informed user role.

13. The method of claim 11, wherein the planning engine generates a new relational database record for each assigned work package task, the record comprising a task identifier, an identifier of the designated personnel, associated transmittal data, and a target deadline.

14. A computer-implemented system for mining operations execution, the system comprising:
a processing unit having a data parsing engine and a planning engine operatively coupled thereto; and
a non-transitory computer-readable medium having stored thereon program instructions executable by the processing unit for:
obtaining transmittal data describing one or more work activities to be performed in a mining environment;
applying, at the data parsing engine, mining-specific rule-based semantic parsing to the transmittal data to extract therefrom a plurality of work package tasks, each work package task having at least one of a deadline, a task description, at least one required worker qualification, a resource requirement, and a cost estimate associated therewith;
assigning, at the planning engine, each work package task to designated personnel; and
outputting, via a graphical user interface, the plurality of work package tasks as assigned.

15. The system of claim 14, wherein the program instructions are further executable by the processing unit for:
querying a central database with a selected one of the plurality of work package tasks, the central database having stored therein a plurality of execution records comprising execution data indicative of at least one of planned tasks, actual completed tasks data, observation data, and equipment-related data;
obtaining, based on the querying, execution data for the selected work package task; and
rendering, within an execution interface of the graphical user interface, the execution data in association with the selected work package task.

16. The system of claim 15, wherein the program instructions are further executable by the processing unit for:
querying the central database with the selected work package task, the central database having further stored therein a plurality of governance records comprising a plurality of governance indicators indicative of at least one of a task schedule status, a risk status, a decision status, and an operational readiness status;
automatically filtering, based on the querying, the plurality of governance indicators to obtain a subset of governance indicators specific to the selected work package task; and
rendering the subset of governance indicators within the execution interface along with the execution data.

17. The system of claim 16, wherein the program instructions are further executable by the processing unit for:
receiving user input in response to a user interacting with at least one interface element provided in the execution interface; and
generating, based on the user input, a governance interface separate from the execution interface, the governance interface presenting the subset of governance indicators in association with the selected work package task.

18. The system of claim 17, wherein the program instructions are further executable by the processing unit for:
establishing a bidirectional propagation path between the plurality of execution records and the plurality of governance records; and
in response to receiving a write event updating an execution record or a governance record, propagating, via the bidirectional propagation path, updated field values from the execution record or the governance record respectively into a corresponding governance record or a corresponding execution record.

19. The system of claim 14, wherein the program instructions are executable by the processing unit for applying, at the data parsing engine, the mining-specific rule-based semantic parsing to the transmittal data by:
applying a tokenizer to segment the transmittal data into discrete lexical units;
matching the discrete lexical units against a dictionary of mining-specific keywords; and
extracting the plurality of work package tasks based on the matching.

20. The system of claim 14, wherein the program instructions are further executable by the processing unit for assigning, at the planning engine, each work package task to the designated personnel by querying a pre-configured role assignment matrix stored in a relational database, the role assignment matrix comprising a plurality of role assignment records defining a plurality of user roles for the plurality of work package tasks.
